(19) United States
(12) Patent Application Publication
(10) Pub. No.: US 2016/0123537 A1
(43) Pub. Date: May 5, 2016

(54) FLEXIBLE INTERFACE CLOSED CYCLE CRYOCAST WITH REMOTELY LOCATED POINT OF COOLING

(71) Applicant: BRUKER BIOSPIN CORPORATION, Billerica, MA (US)

(72) Inventors: Arthur H. Heiss, Brookfield, CT (US); Ajay Khatri, Bethlehem, PA (US)

(21) Appl. No.: 14/434,662

(22) PCT Filed: Jul. 28, 2014
(86) PCT No.: PCT/US14/48440

§ 371 Date: Apr. 9, 2015

Related U.S. Application Data
(60) Provisional application No. 61/859,030, filed on Jul. 26, 2013.

(51) Int. Cl. F17C 9/00; F16L 9/19

(52) U.S. Cl. CPC F17C 9/00; F16L 9/19; F17C 2227/00

(57) ABSTRACT

A closed cycle cryocooler system for cooling a sample includes a cryocooler that receives helium gas and provides a cooled helium gas, a flexible interface that receives the cooled helium gas and provides the cooled helium gas to a rigid stinger assembly configured and arranged to provide the cooled helium gas to a cryostat. The flexible interface may include a first gas flow path that routes gas to the rigid stinger assembly, and a second gas flow path receives return gas from the rigid stinger. The first gas flow path may be radially interior with respect to the second gas flow path

### 1. CLAIM OF PRIORITY

This application claims priority from U.S. Provisional Patent Application Ser. No. 61/859,030, filed Jul. 26, 2013, which is hereby incorporated by reference.

### 2. FIELD OF TECHNOLOGY

The present disclosure relates to cryogenic cooling of test samples with either an open cycle or closed cycle system, and in particular to cryogenic cooling of a test sample with either an open cycle or closed cycle system with a flexible interface.

### 3. RELATED ART

Most cryogenic systems employed in cooling test samples are either open cycle or closed cycle systems.

In an open cycle system, liquid Cryogen (helium or nitrogen) is extracted from a liquid dewar using a liquid transfer line and injected in the cryogenic system to achieve the desired temperature at the sample under test. Cryogen is then exhausted into the atmosphere. This is both expensive, logistically difficult and does not allow long-term operation of the system since the liquid dewar needs to be frequently replaced. In this case however the sample can be remotely located from the liquid dewar and the discharge end of the transfer line is inserted into the cryogenic system to provide cooling at the desired location of sample.

In a closed cycle system, a cryocooler is employed to provide desired temperature at the cold stage of the cryocooler. An extension rod or similar setup is attached to the cold station to provide cooling to the cryogenic test sample, which is remote from the cryocooler. This approach has several drawbacks. These prior art systems transmit vibrations from the cryocooler to the test sample, which is not desirable. These prior art systems also create loss in temperature and thus increases the temperature of the extension rod at the end connected to the point of cooling. This approach is also relatively bulky, creates difficulty in positioning of system and requires a large opening in the cryogenic system to insert the cryocooler cold end. These problems become severe when very low temperature of liquid helium (e.g., 4.2 K) or below is desired at the sample.

There is a need for an improved system.

### SUMMARY OF THE DISCLOSURE

A closed cycle cryocooler system for cooling a sample includes a cryocooler that receives helium gas and provides a cooled helium gas, a flexible interface receives the cooled helium gas and provides the cooled helium gas to a rigid stinger assembly configured and arranged to provide the cooled helium gas to a cryostat. The flexible interface may include a first gas flow path that routes gas to the rigid stinger assembly, and a second gas flow path receives return gas from the rigid stinger. The first gas flow path may be radially interior with respect to the second gas flow path.

A system includes a cryocooler that receives gas and provides a cooled gas. A flexible interface receives the cooled gas and provides the cooled gas along a first gas flow path to a rigid stinger assembly, and receives return gas from the rigid stinger assembly via a second gas flow path, where the first gas flow path is radially interior with respect to the second gas flow path.

It is to be understood that the features mentioned above and those to be explained below can be used not only in the respective combinations indicated, but also in other combinations or in isolation.

These and other objects, features and advantages of the invention will become apparent in light of the detailed description of the embodiment thereof, as illustrated in the accompanying drawings.

### DESCRIPTION OF THE DRAWINGS

FIGS. 1 and 2 are pictorial illustrations of a cryocooler that has a flexible interface and a stinger assembly attached a cryostat;

FIG. 3 is a block diagram illustration of the system of FIGS. 1 and 2.

FIG. 4 is a block diagram illustration of a helium auxiliary circuit;

FIGS. 5A-5G are various cross sectional illustrations of the flexible interface and the stinger assembly;

FIG. 6 illustrates a cryocooler having a flexible interface that includes a stinger assembly comprising an integrated cold tip at the end of the stinger;

FIG. 7 is an illustration of a cryocooler, flexible interface and stinger.

FIG. 8 is a further illustration of the flexible interface.

### DESCRIPTION

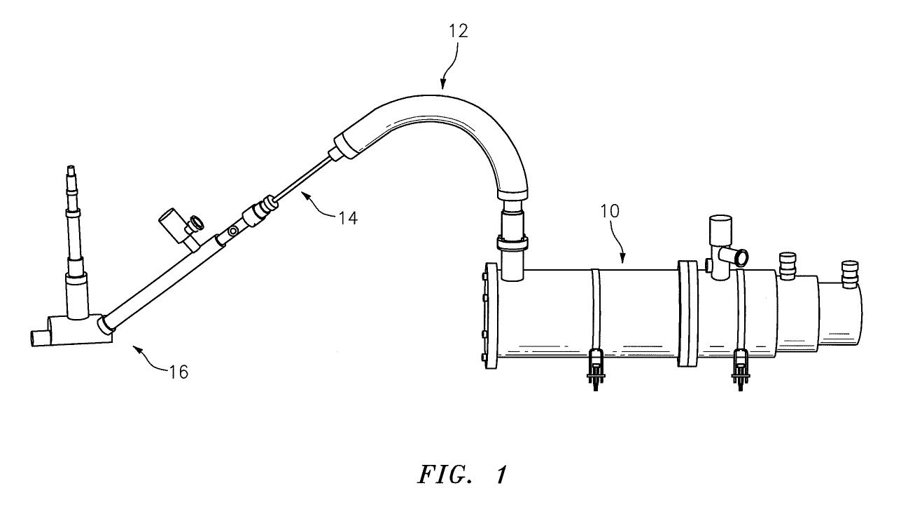

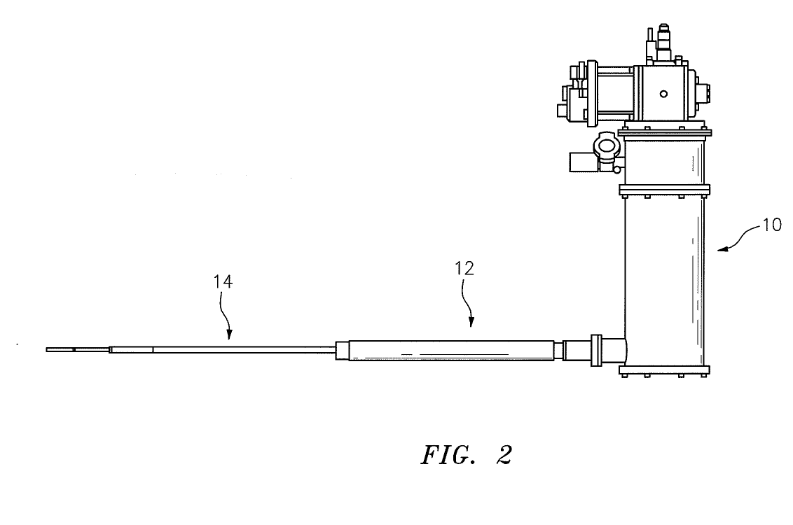

FIG. 1 is a pictorial illustration of a cryocooler 10 that has a flexible interface 12 and a stinger assembly 14, where the stinger assembly is attached a cryostat 16. The cryocooler 10 may be a closed cycle two-stage cryocooler that uses a helium gas circuit in a closed loop to achieve temperature of about 10 K and below (e.g., about 4.2 K and below). The cryocooler may be based on a Gifford McMahon (GM) cycle, Pulse Tube (PT) type, or any other type. The cryocooler 10 also has flexible point of cooling interface. This flexible interface 12 has the stinger 14 (e.g., rigid in comparison to the flexible interface) at the end. The cold helium gas is passed through the stinger 14 and injected into the device to be cooled. The gas then returns to the cryocooler exhaust side of the circuit. Then it is either re-circulated using a closed recirculation loop or exhausted to atmosphere. FIG. 2 is another pictorial illustration of the cryocooler 10.

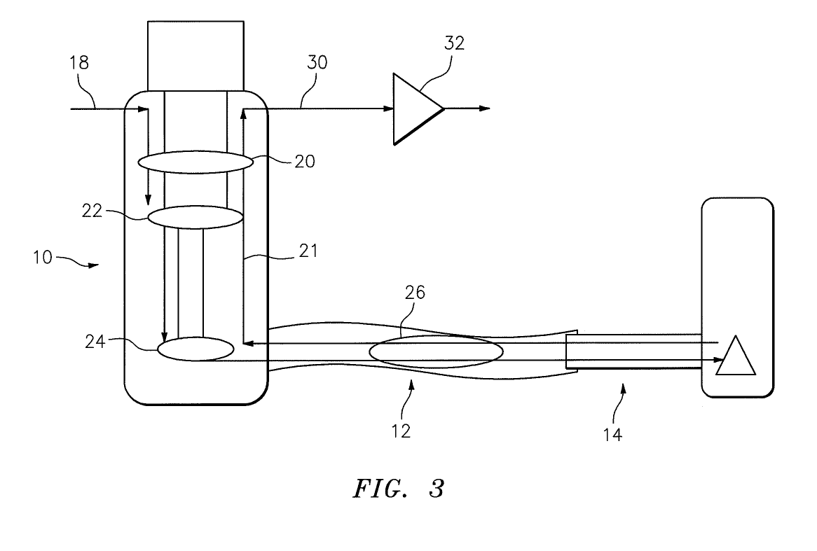

Referring to FIG. 3, the helium gas may be supplied from either a commercially available helium bottle or a closed loop helium compressor and connected to an inlet port 18. The room temperature gas then passes through first heat exchanger #1 20 (e.g., counter-flow) that cools the gas from room temperature to an intermediate lower temperature by using the cooling power of the colder return gas, for example flowing along flow path 21. The pre-cooled gas then passes through a second heat exchanger #2 22, that is in thermal contact (e.g., direct) with the first stage of the cryocooler. The helium gas is further cooled on this stage closer to the first stage temperature of the cryocooler, ranging from about 30 K to 100 K. The gas then passes through a third heat exchanger #3 24 that is in thermal contact (e.g., direct) with the second stage of the cryocooler (which is at the lowest temperature that the two-stage cryocooler can achieve). The gas is cooled to a temperature close to the second stage of the cryocooler, for example typically ranging from about 4 K to 25 K.

Referring still to FIG. 3, this cooled gas then passes through the flexible interface 12 and the stinger assembly 14. The cold flow from the second stage of the cryocooler passes through a radially innermost supply tubing of the flexible interface 12 and the stinger 14. It then passes through a Joule Thomson device which may for example be an orifice, a capillary tubing or any such arrangement and undergoes expansion from high pressure to low pressure. This process creates an additional drop in temperature. This can result in either cold gas or a mixture of cold gas and liquid at low pressure. This low pressure low temperature flow cools down the sample. The low pressure cold gas then returns through a counter flow heat exchanger 26 in the flexible interface 12. The gas then goes back into the gas return part of the helium circuit in the cryocooler section, and there it provides cooling to the incoming room temperature high pressure helium in the heat exchanger #1 20. The gas then exits the system through the exhaust port 30.

An example of a cryogen free cooling system is disclosed in U.S. Patent Application Publication 2013/0021032, which is hereby incorporated by reference.

Referring to FIG. 3, the helium circuit may also employ a vacuum pump 32. This allows the user to reduce the pressure on the exhaust side, and at the sample, which results in even lower temperature. Temperature below 3 K has been achieved using this technique. Without using the vacuum pump temperature of about 4.2 K (liquid helium temperature at normal atmospheric pressure) has been achieved.

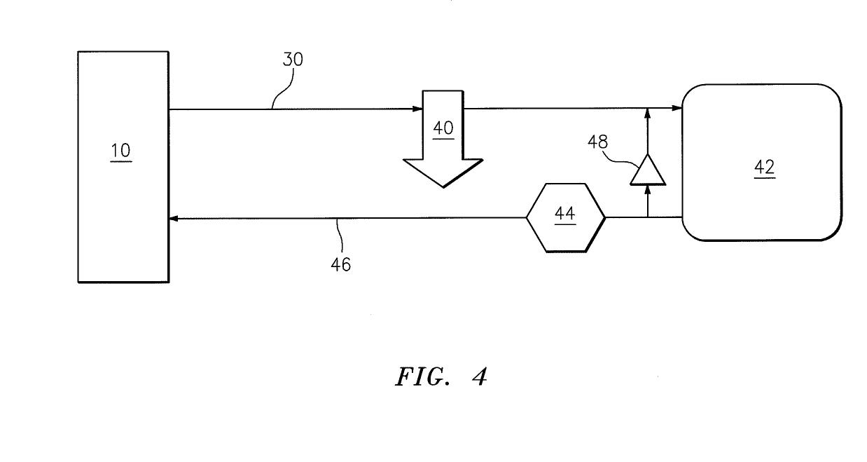

The helium auxiliary circuit may be closed by using a setup as illustrated in FIG. 4. Helium returned from the cryocooler system is passed through an optional liquid nitrogen trap 40 and then goes to a return side of a compressor 42. The high pressure helium from the compressor is regulated through a pressure regulator 44 to supply a constant pressure gas stream to the cryocooler inlet 46. The supply and return sides of the compressor are connected through a bypass regulator 48 that allows the return side of the compressor to be maintained at a desired pressure. It also prevents the compressor pressure from falling into an unsafe region that may damage the compressor 42.

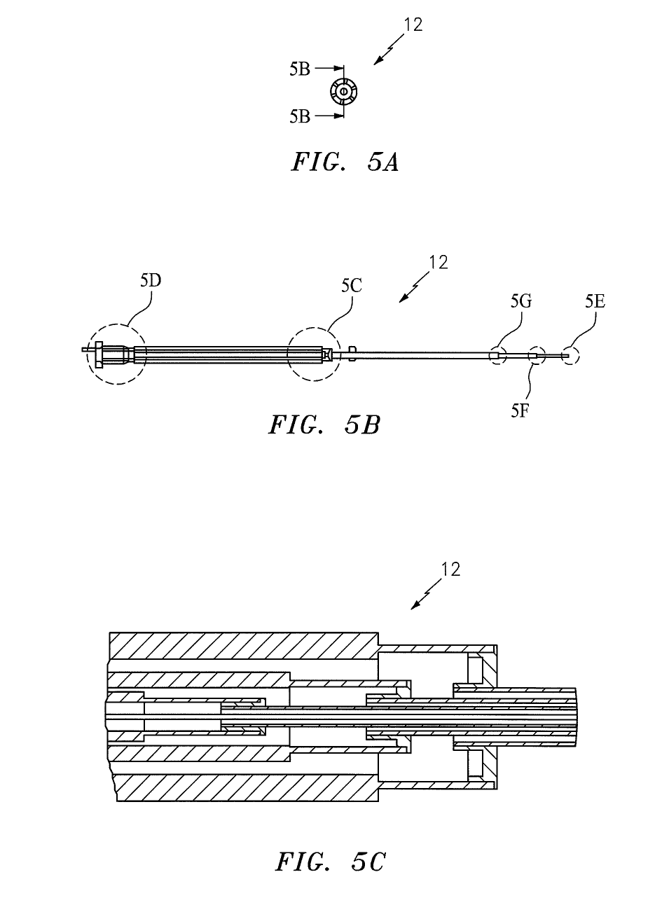

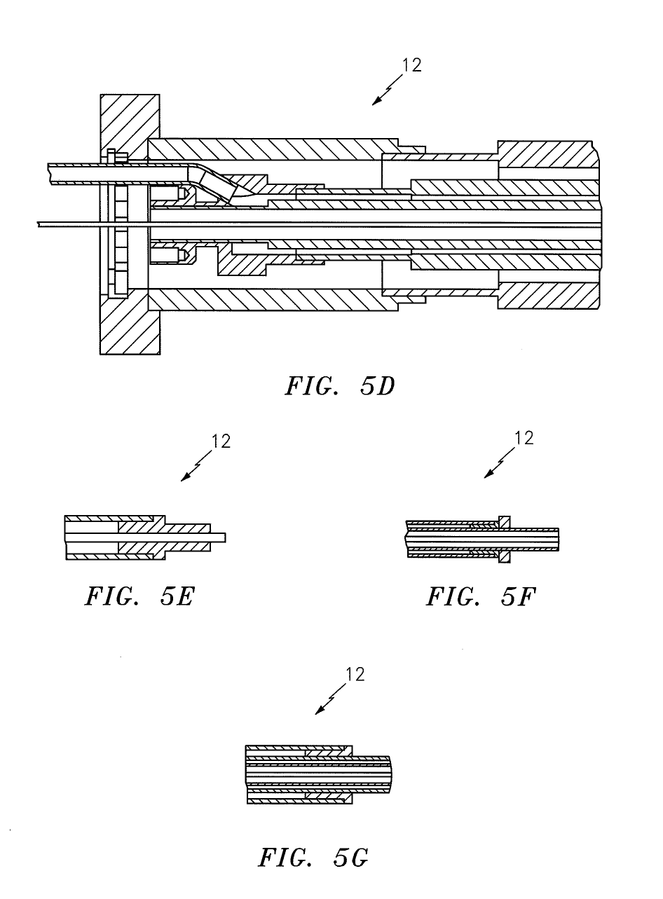

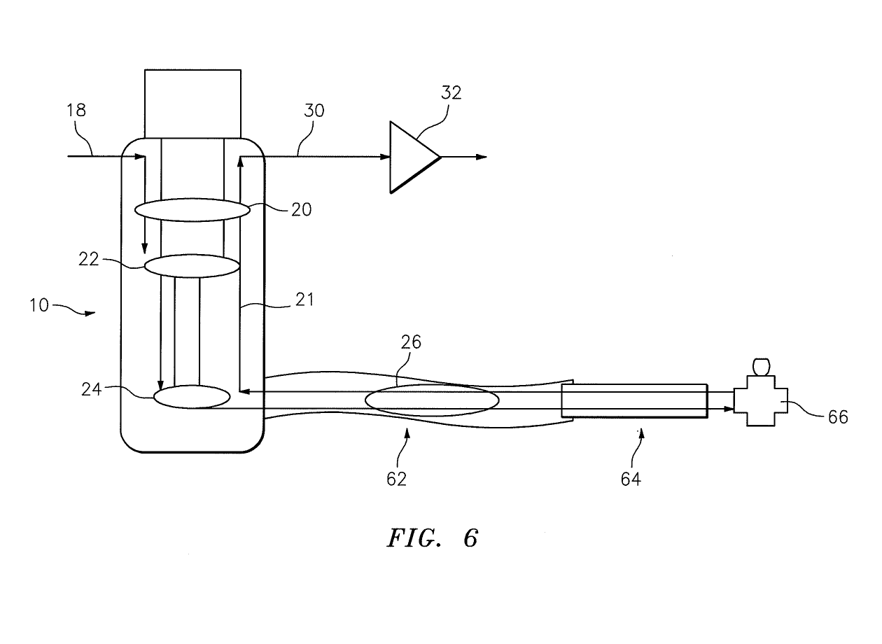

The flexible interface 12 may include an arrangement of concentric flexible tubing as shown in FIGS. 5A-5G. The flexible interface 12 and the stinger assembly 14 are preferably non-magnetic, such as for example stainless steel. However, depending upon the application, a skilled person will recognize that the interface is not limited to non-magnetic materials. As shown in FIGS. 5C and 5D, the supply of cold flow from the second stage of the cryocooler passes through the innermost tubing of the flexible interface 12. Then it enters the innermost tube of the rigid part of the stinger. It then passes through a Joule Thomson device and undergoes expansion from high pressure to low pressure. This process creates an additional drop in temperature, thus a cooling effect on the device being cooled. Referring to FIGS. 5B-5G, the low pressure return gas then passes through annular space (e.g., created by two flexible tubings) in the flexible interface 12, and back into the gas return part of the helium circuit.

In an electron paramagnetic resonance (EPR) setup, the cooled gas may be passed through tubing that is integrated with a glassware assembly of the EPR setup. The design is such that the glassware is independently removable. The low pressure cold helium then passes through the glassware inner boundary and enters the return part of the helium circuit. This cold gas is directed into the counter-flow heat exchanger described above which provides cooling to the incoming warmer gas. Then the helium gas is exhausted into atmosphere or can be collected in a recovery system for helium or re-circulated using a closed loop system. Of course one of ordinary skill in the art will recognize that the flexible interface is not limited to EPR systems, and the interface may be used for various other applications that would benefit from the cold sample temperature and benefits provided by the flexible interface.

FIG. 6 illustrates a cryocooler having a flexible interface 62 that includes a stinger assembly 64 connected to an integrated cold tip 66. The integrated cold tip 66 allows the gas to flow inside it after Joule Thomson expansion and cool down the cold tip. It also provides a path for the return gas to get back into the return path of the flow circuit. The cold tip 66 may include a radiation shield attached on the stinger body to provide a cold shield to the sample to be cooled. The sample may be attached on the cold tip 66 directly. This allows significant flexibility in setting of remotely cooled cryogenic devices.

The stinger assembly 14 may be designed to mate with existing cryogenic systems that researchers already have. Thus, a researcher can continue on use the cryogenic system they already have, and not depend on expensive and difficult to get liquid helium for operation. The older systems were designed to work with the liquid helium delivery systems only. Until now, there was no way to use them with closed cycle cryocooler and achieve performance similar to liquid cryogens. Prior art systems do not allow for a flexible interface and mate with the existing cryogenic systems.

The heat exchangers illustrated in FIGS. 3 and 6 are designed to preferably maximize the efficiency and performance of the system. The heat exchangers may be for example matrix type, tube-in-tube type, single flow or counter-flow types as necessary to achieve performance. The heat exchangers take advantage of the return helium flow to achieve the minimum temperature. A skilled person of ordinary skill will assess the temperature of the return helium coming out of the test setup to decide the locations and types of the heat exchangers. Additional heat exchangers may be integrated in the helium flow circuit such that they are attached to the cryocooler cylinder between the room temperature surface and the first stage, which is typically around 30-40 K. For example, additional heat exchangers may be integrated between the first and second stage part of the cylinder such that second stage reaches about 10 K to 3 K temperature. This provides additional cooling capacity to the gas flow and this allows larger flow rate in the helium circuit to cool larger mass or heat load.

The system may be configured such that the helium gas supply pressure can be manipulated higher or lower depending upon the heat load on the system and mode of operation. During a stand-by mode the pressure can be decreased to very low values, so the system does not use much helium gas but the system stays cool until ready to use. Then the pressure can be increased to achieve the desired flow and minimum operating temperature. This provides maximum flexibility in operation and reduces operational cost and down time.

Primary beneficiaries of the flexible interface are researchers and scientists. A researcher can keep on using the cryogenic system they already have, and no longer depend on expensive and difficult to get liquid helium for operation. The older systems were designed to work with the liquid helium delivery systems only. Until now, there was no way to use them with closed cycle cryocooler and achieve similar performance. The flexible interface 12 may comprise flexible hose, may be moved for example into bowed positions as shown in FIG. 1.

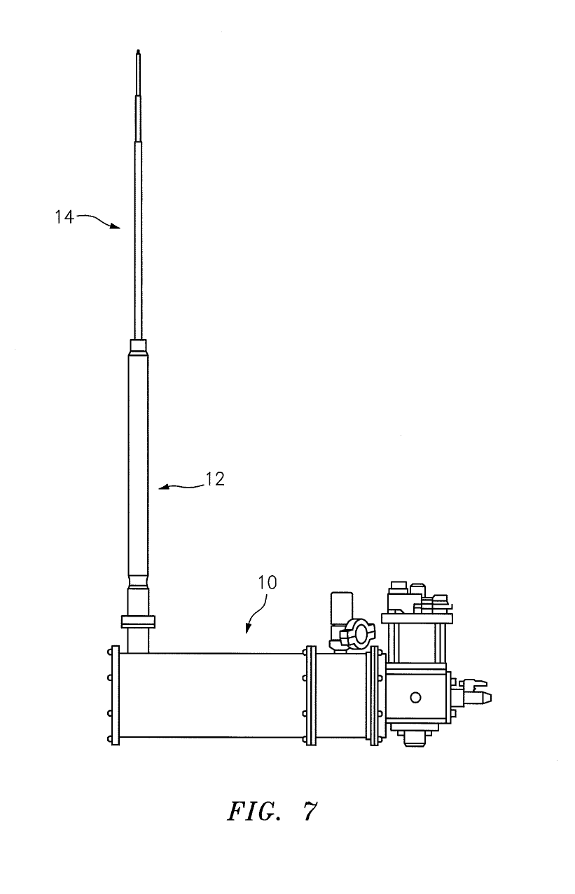

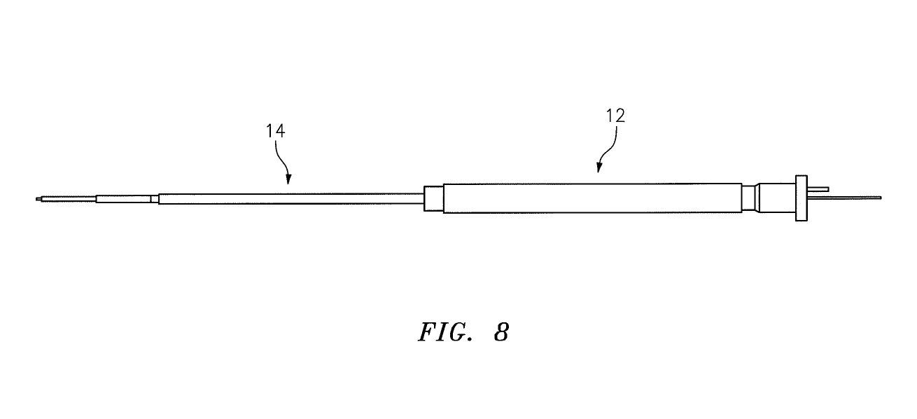

FIGS. 7 and 8 are further illustrations of the flexible interface and the stinger assembly.

Another advantage is that it is not sensitive to orientation of the cryogenic system.

For example, the flexible interface does not depend on any specific orientation (e.g., horizontal, cold tip up, cold tip down or at specific angle). This new invention will work with all of them. Other advantages, include for example low temperature operation, an adjustable bayonet design to fit multiple cryogenic systems, concentric flow provide better thermal shield to inner cold flow of gas, flexible interface allows ease of installation with rigid stinger provide adjustable interface, cryogenic filters can be added to gas flow circuit to make it insensitive to contamination, gas circuit can be completely closed loop using auxiliary gas circulation system, auxiliary closed loop may have adjustable return pressure to provide temperature control, the system can be cryo trapped for system decontamination purpose, heat exchangers mounted with cryocooler cylinder mallow provide better cooling performance and higher cooling power, high or low pressure flow capabilities to provide idle mode of operation, and the system can operate with high pressure helium bottle or standard helium compressor operating between 50 to 150 psi supply pressure.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A closed cycle cryocooler system for cooling a sample, comprising:
a cryocooler that receives helium gas and provides a cooled helium gas; and
a flexible interface that receives the cooled helium gas and provides the cooled helium gas to a rigid stinger assembly configured and arranged to provide the cooled helium gas to a cryostat.

2. The system of claim 1, wherein the flexible interface comprises a flexible hose.

3. The system of claim 2, wherein the flexible interface comprises a plurality of radially concentric longitudinal gas flow paths.

4. The system of claim 2, wherein the flexible interface comprises a plurality of radially concentric longitudinal gas flow paths and a heat exchanger.

5. A system, comprising:
a cryocooler that receives gas and provides a cooled gas; and
a flexible interface that receives the cooled gas and provides the cooled gas along a first gas flow path to a rigid stinger assembly, and receives return gas from the rigid stinger assembly via a second gas flow path, where the first gas flow path is radially interior with respect to the second gas flow path.
